(19) United States
(12) Patent Application Publication
(10) Pub. No.: US 2023/0409039 A1
(43) Pub. Date: Dec. 21, 2023

(54) VEHICLE AND METHOD FOR CONVEYING LOAD UNITS ONTO THE VEHICLE

(71) Applicant: FRAUNHOFER-GESELLSCHAFT ZUR FORDERUNG DER ANGEWANDTENFORSCHUNG E.V., Munchen (DE)

(72) Inventors: Jan BEHLING, Dortmund (DE); Mathias; ROTGERI, Dortmund (DE); Jan Soren EMMERICH, Herdecke (DE); Dirk; HONING, Bochum (DE); Patrick KLOKOWSKI, Castrop-Rauxel (DE); Christian HAMMERMEISTER, Dortmund (DE); Michael TEN HOMPEL, Dortmund (DE)

(21) Appl. No.: 18/035,917

(22) PCT Filed: Sep. 15, 2021
(86) PCT No.: PCT/EP2021/075321

§ 371 Date: May 8, 2023

(30) Foreign Application Priority Data
Nov. 8, 2020 (DE) 102020129383.6

(51) Int. Cl. G05D 1/02

(52) U.S. Cl. CPC G05D 1/0225; G05D 2201/0216

(57) ABSTRACT

A vehicle having a chassis (5), having a drive device (30) and having a vehicle frame (10) which is arranged on the chassis (5) and which has a receiving component (7) for the placement of at least one payload unit (L) that is situated in an operating area, wherein the vehicle (1) has a vehicle system (S) having: •a control function (50) which, on the basis of control setpoint specifications, determines control commands and transmits these to the drive device (30), •a docking specification function (60), which generates a setpoint docking trajectory for the vehicle (1) to attain a setpoint docking state, wherein, in the setpoint docking state, the vehicle (1) is docked by way of a contact device of the vehicle frame (10) on a docking device (101) of a tool device (100), wherein the docking specification function (60) transmits the setpoint docking trajectory to the control function (50) as a control setpoint specification for the movement of the vehicle (1) along said setpoint docking trajectory, •a manoeuver specification function (70) with a manoeuver trajectory generating function which, on the basis of a respective actual tool state, determines a reference point manoeuver trajectory and, in a manner dependent thereon, uses the tool movement model to determine a vehicle manoeuver trajectory into a setpoint receiving state of the vehicle (1), along which vehicle manoeuver trajectory the vehicle (1) manoeuvers the tool device (100) from the actual tool state into a setpoint tool state in which a reference point position of the reference point is situated within a setpoint difference in relation to a payload unit position of the payload unit (L), wherein, with regard to the vehicle manoeuver trajectory, the manoeuver specification function (70) transmits control setpoint specifications, for the movement of the vehicle (1) along the vehicle manoeuver trajectory, to the drive device.

### CLAIM TO PRIORITY

This application claims priority to and the benefit of the following pending application PCT/EP2021/075321 having an International filing date of 15, Sep. 2021 (15.09.2021) which claims priority to Priority Application No. DE 10 2020 129 383.6 having a priority date of November 2020 (Aug. 11, 2020).

### FIELD OF INVENTION

The invention relates to a vehicle and a method for conveying or transferring load units to the vehicle.

### BACKGROUND

The method according to the invention can be used, in particular, in the field of sorting systems for charge carriers in the form of packets in the region of sorting systems and in particular in a packet center or for load units in the form of luggage items of an airport or generally in distribution centers. The load units may have been delivered into the area of a sorting plant, in particular by transport vehicles such as trucks, line vehicles or ships or aircraft.

A method for coupling robots is known from DE 103 35 568 A1. In order to carry out a precisely predetermined manufacturing process in a predetermined manufacturing position in an automated manufacturing environment, the course to be traveled is determined by one of the robots in the coupled state and transmitted to the other robot, so that both robots are have information on the course to be driven and both autonomously drive this course in the coupled state. The robots approach each other for coupling by lateral flanks of projections and recesses which are shaped in a complementary manner to one another on two vehicles. When the projections and recesses engage each other, the vehicles are locked together. The vehicles can also be realized without projections and recesses. In this case, the approaching and coupling of the vehicles takes place purely by sensorially.

DE 10 2019 122 055 A1 describes a method for transferring cargo from a receiving component of a vehicle to a load takeover station. In this method, the vehicle is controlled by a vehicle controller such which the speed vector of the vehicle changes immediately before or at the load transfer station. DE 10 201 9 122 055 A1 also describes a vehicle comprising a receiving component which comprises an edge boundary on a side edge.

DE 10 2015 114 370 B4 describes a transport system with an autonomously movable driverless transport train, a transfer station and a ramp/pit arrangement and a storage and picking system.

DE 10 2018 117 844 A1 describes a transfer station for a transport device in order to deliver transport goods and/or piece goods to a transport vehicle traveling in a transport direction by means of a transfer rake. The transfer rake comprises two parallel conveying rails on which transport goods are conveyed lying on the same and which can be rotated by means of a rotary drive about a horizontal axis of rotation or can be moved in the vertical direction by means of a lifting drive in order to transfer the transport material to a transport device in a force-assisted manner.

DE 10 2018 117 844 A1 also describes a transport vehicle for the transfer station, wherein the transport vehicle takes over transport goods at the transfer station and transports it away from the latter or the transport vehicle transports transport goods to the transfer station and transfers it there to the transfer rake. Furthermore, DE 10 2018 117 844 A1 discloses a transport device comprising a conveying device and such a transfer station.

The object of the invention is to provide a vehicle and a method with which load units located on an operational surface or in an operational area can be charged and transported further in the most efficient manner.

### SUMMARY

According to the invention, a vehicle comprising a running gear, a drive device, a vehicle system and a receiving component is provided. The drive device is connected to the running gear and adjusts a velocity vector of the vehicle on an operational surface, wherein the velocity vector can also be equal to zero. The vehicle is able to couple to a tool device in a self-controlling manner and to move the same in a state and in particular position and specifically additionally orientation, in which the tool device can receive a load unit from an operational surface of an operational area and convey the same to a receiving surface of the vehicle and can thus arrange it.

In this case, the vehicle system generates a target docking trajectory from any desired position of the vehicle in which the vehicle is located at a distance from the tool device to a target docking state in which the vehicle is docked on the tool device.

“Docking” is understood here in particular as:
(D1) An outer surface of the vehicle contacts an outer surface of the tool device.
(D2) The vehicle is coupled to the tool device, for example via a mechanical coupling device.

The vehicle system furthermore generates a reference point maneuvering trajectory for a reference point of the tool device, according to which the movement of the vehicle is controlled and the tool device, when the vehicle is in a state docked on the tool device, is maneuvered from a respective tool actual state into a tool target state. In the tool target state, the tool device has, in particular, a target orientation and a target position relative to a load unit located on the operational surface. Alternatively or additionally, the target tool state can be defined in such a way that a reference point position of the reference point is situated within a target difference to a load unit position of the load unit. Depending on the embodiment of the tool device, the target tool state is a state on the operational surface in which the tool device can receive the load unit and can convey and place or dispose the load unit on the receiving component of the vehicle.

Due to the fact which the control of the vehicle takes place on the basis of the target docking trajectory and the reference point maneuvering trajectory, the movement of the vehicle from a vehicle actual state of the vehicle up to a target docking state of the vehicle and from the latter into a target receiving state of the vehicle takes place in an efficient manner, since the vehicle itself is able to optimize this process by presetting corresponding trajectories or selection of corresponding trajectories.

By means of the vehicle according to the invention, the tool device can be designed in a simple manner, so that the method according to the invention is overall efficient. The tool device comprises a receiving device for receiving a load unit from the operational surface and for conveying the load unit to a receiving component of the vehicle. For example, the tool device can be realized without a running gear, so that the tool device slides on the operational surface when the tool device is maneuvered by the vehicle. Furthermore, the tool device can be realized without a control device. The tool device can also be implemented without a sensor system for detecting the tool actual state or a tool setpoint state or both states.

The vehicle according to the invention can in particular be realized with a vehicle system which comprises a control function which is functionally connected to the drive device and determines control commands on the basis of control target data and transmits said commands to the drive device. The vehicle system comprises, in particular, a docking setting function and a maneuvering setting function.

According to the invention, in particular a vehicle is provided, which comprises: a running gear, a drive device which is connected to the running gear and which adjusts a speed vector of the vehicle on an operational surface, and a vehicle frame which is arranged on the running gear and comprises a receiving component for placing at least one load unit situated on the operational surface, wherein the vehicle comprises a vehicle system comprising: a control function which is functionally connected to the drive device and determines control commands on the basis of control target data and transmits said commands to the drive device in order to adjust a speed vector of the vehicle, a docking setting function which generates a target docking trajectory for the vehicle to a target docking state based on data defining a vehicle actual state of the vehicle at least with an actual position, wherein the target docking state is described by data which define at least a target position and wherein, in the target docking state, the vehicle is docked with a contact device of the vehicle frame on a docking device of a tool device, wherein the docking setting function transmits the target docking trajectory to the control function as a control target data for moving the vehicle along the target docking trajectory, a maneuvering setting function comprising a tool movement model which converts data defining a tool actual state at least with a tool actual position and with a tool actual orientation of a reference point of the tool device into data defining a vehicle actual position and a vehicle actual orientation when the vehicle is in a state docked with the tool device, wherein the maneuvering setting function comprises a maneuvering trajectory generation function which determines, on the basis of a respective tool-actual state, a reference point maneuvering trajectory and which, as a function of the latter, with the tool movement model determines a vehicle maneuvering trajectory into a target receiving state of the vehicle along which the vehicle maneuvers the tool device from the tool actual state to a tool target state in which a reference point position of the reference point is located within a target difference to a load unit position of the load unit, wherein the maneuvering setting function transmits control target data with respect to the vehicle maneuvering trajectory for moving the vehicle along the vehicle maneuvering trajectory to the drive device.

In each of the embodiments of the vehicle according to the invention, it can be provided that the vehicle comprises a receiving function which holds the vehicle in this state from the point in time at which the vehicle is in the target receiving state relative to the tool setpoint state of the tool device until it has conveyed a load unit onto the receiving surface.

In each of the embodiments of the vehicle according to the invention, it can be provided that the vehicle comprises an electrical contacting device which is formed on a contact surface of the vehicle frame for application to a docking device of the tool device.

In each of the embodiments of the vehicle according to the invention, it can be provided that the vehicle comprises a vehicle function interface for connection to a tool function interface which is formed on a contact surface of the vehicle frame for application to a contact surface of a docking device of the tool device and which is designed to transmit an initiation signal for activating a receiving function of the tool device for conveying the load units onto the receiving component of the vehicle.

In each of the embodiments of the vehicle according to the invention, it can be provided that the vehicle comprises a vehicle system with a vehicle communication device which can be brought into radio contact with a logistics device stationary in the operational area and, upon receipt, transmits data defining a load unit position of at least one load unit to the maneuvering trajectory generation function.

In each of the embodiments of the vehicle according to the invention, it can be provided that the vehicle comprises a vehicle system with a vehicle communication device which can be brought into radio contact with a logistics device stationary in the operational area and, upon receipt of data relating to the tool-actual state of at least one tool device from the logistics device, transmits this data to the maneuvering trajectory generation function.

In each of the embodiments of the vehicle according to the invention, it can be provided that the vehicle comprises a vehicle system with a vehicle communication device, which can be brought into radio contact with a tool communication device of at least one tool device, which transmits data related to the tool-actual state of the tool device to the maneuvering trajectory generation function.

In each of the embodiments of the vehicle according to the invention, it can be provided that the vehicle comprises a vehicle system with a vehicle communication device, which receives from a tool communication device data related to the tool-actual state of the tool device for transmission to the maneuvering trajectory generation function and transmits the data to the maneuvering trajectory generation function on the basis of the receipt.

In each of the embodiments of the vehicle according to the invention, it can be provided that the vehicle comprises a vehicle system with a vehicle communication device which can be brought into radio contact with a tool communication device of at least one tool device or in a line connection with an electrical contacting device which transmits the data related to the tool-actual state of the tool device to the maneuvering trajectory generation function and thereby receives from the tool communication device actual data related to the load unit position of the load unit at least one load unit located on the operational surface.

In each of the embodiments of the vehicle according to the invention, it can be provided that the vehicle comprises a vehicle system with a prioritization function with which, according to a tool selection criterion at an actual point in time, a tool device is selected as the next tool device from the tool devices located on the operational surface at the actual point in time to be headed for by the vehicle with a target trajectory.

In each of the embodiments of the vehicle according to the invention, it can be provided that the vehicle comprises an identification character sensor which is arranged on the receiving component of the vehicle in order to capture an identification character of a load unit. In these embodiments of the vehicle according to the invention, the identification character sensor can be arranged in the direction of gravity direction below a receiving surface of the receiving component in order to detect an identification character of a load unit.

In each of the embodiments of the vehicle according to the invention, it can be provided that the contact device of the vehicle frame is an outer surface or a coupling device of the vehicle.

According to a further aspect of the invention, a method for moving a vehicle on an operational surface and for conveying at least one load unit located on the operational surface is provided on a receiving component of the vehicle, the method comprising the following steps: docking the vehicle to a tool device by controlling the vehicle along a target docking trajectory, determined by a docking setting function based on data defining a vehicle actual state of the vehicle with at least one actual position, to a target docking state of the vehicle, wherein the target docking state is described by data which define at least one target position and wherein, in the target docking state, the vehicle contacts a contact device of the vehicle frame of the tool device, maneuvering the tool device on which the vehicle is docked by controlling the vehicle along a vehicle maneuvering trajectory to a target receiving state of the vehicle as a control target data, wherein the vehicle maneuvering trajectory has been determined on the basis of a reference point maneuvering trajectory and a tool movement model, which converts data related to a tool-actual state with a tool-actual position and a tool-actual orientation of a reference point of the tool device into data which define a vehicle-actual position and a vehicle-actual orientation, wherein, in the target receiving state of the vehicle, the reference point of the tool device is situated in a predetermined relative state with respect to the actual position of the load unit.

In each of the embodiments of the method according to the invention, it can be provided that, after reaching the target receiving state of the vehicle, the control function generates control target data with which the vehicle is held in the vehicle receiving state relative to the tool receiving state of the tool device until the tool device has conveyed a load unit onto the receiving component.

In each of the embodiments of the method according to the invention, it can be provided that the tool device determines position data relating to an actual position of the tool device by means of a position sensor device and transmits the data to a tool communication device,

wherein the tool communication device transmits the position data related to an actual position of the tool device via radio or via a line connection with an electrical contacting device to a vehicle communication device, wherein the vehicle communication device transmits the position data related to an actual position of the tool device, after reception the same, to the maneuvering trajectory generation function.

In each of the embodiments of the method according to the invention, it can be provided that the tool device determines actual data relating to a load unit position of at least one load unit located on the operational surface by means of a load unit sensor, and transmits the data via a radio contact or via an electrical line connection to an electrical contacting device to a vehicle communication device, and that the vehicle communication device transmits the position data related to a load unit position of the at least one load unit after receiving the same to the maneuvering trajectory generation function.

In each of the embodiments of the method according to the invention, it can be provided

that the vehicle system selects, by means of a prioritization function, according to a tool selection criterion, at an actual point in time a tool device as the next tool device from the tool devices located on the operational surface at the actual time to be controlled by the vehicle with a target trajectory, and that, on the basis of the selection of the tool device to be headed for next, an initiation of the docking setting function and the determination of the target docking trajectory to the target docking state of the vehicle at the docking device of the selected tool device takes place.

In these embodiments of the method according to the invention, it can be provided that the tool selection criterion performs a comparison of distances between actual positions of the respective tool devices received by the vehicle system and an actual position of a load unit located on the operational surface received by the vehicle system and selects which tool device comprises a smallest distance from the load unit.

Furthermore, in these embodiments of the method according to the invention, it can be provided that the tool selection criterion performs a comparison of distances between actual positions of the respective tool devices received by the vehicle system and the actual position of the vehicle and selects which tool device comprises a smallest distance from the load unit.

In each of the embodiments of the method according to the invention, it can be provided that after the docking of the vehicle with a contact device of the vehicle frame on the docking device of a tool device and after the maneuvering of the tool device into the tool target state, the tool device conveys the load unit to the receiving component of the vehicle by means of a conveying device, that the conveying device comprises an identification character sensor, past which the load unit is moved during the conveying thereof onto the receiving component and an identification character of a load unit is detected, that the identification character sensor of the tool device is functionally connected to the tool communication device and transmits the identification character to the tool communication device after which the identification character has been captured, wherein, after receiving the identification character, the tool communication device transmits the same to a logistics device or the vehicle.

In each of the embodiments of the method according to the invention, wherein, when the load unit is conveyed to the vehicle, an identification character is captured by an identification character sensor of the vehicle, wherein the identification character sensor of the vehicle is functionally connected to the vehicle communication device and transmits the identification character to the vehicle communication device after which the identification character has been detected, wherein, after receiving the identification character, the vehicle communication device transmits this to a logistics device.

The term “load units” can generally be understood here to mean a charge carrier or container in which material to be transported, such as piece goods or also liquids or gas, is or are contained or not contained in each case. Load units can also be packages or, in particular, closed containers which are open on an upper side with regard to the direction of gravity.

The term “along” herein means in the context of a directional indication referred to herein, which in particular can also relate to the course of a contour line or a surface or a direction of a component or a structural component such as an axis or a shaft or a central axis thereof, with respect to a reference direction or a reference axis, that a portion of the course or the tangent to a respective contour line or respective surface or the direction in an explicitly or implicitly predetermined viewing direction deviates locally or in a section at an angle of at most 45 degrees and in particular of a maximum of 30 degrees from the respective reference direction or reference axis, to which the respective directional indication is related.

The expression “transverse” in the context of a directional indication mentioned herein, which in particular can also relate to the course of a contour line or a surface or a direction of a component or a structural component such as an axis or a shaft or a central axis thereof, in relation to a reference direction or a reference axis, that a portion of the course or the tangent to a respective contour line or respective surface or the direction in an explicitly or implicitly predetermined viewing direction differs locally or in a section at an angle which is between 45 degrees and 135 degrees, and preferably at an angle which is between 67 degrees and 113 degrees, from the respective reference direction or reference axis, to which the respective directional indication is related.

The term “distance” in particular between two surfaces is understood here in particular as the shortest distance.

More specifically herein, a “distance” may be understood to mean, in particular, between two objects or two surfaces or reference points, in particular the shortest distance or the shortest distance between the two objects or surfaces or reference points, wherein the shortest distance or the shortest distance is not equal to zero in terms of magnitude, unless explicitly stated herein in this respect.

A “longitudinal direction” or another reference direction of a reference line, such as in particular a central axis or a centrally extending line or a center line of at least one structural component or of a component and in particular of a guide track, is obtained here in particular as a connecting line of the centroid points of the respectively smallest cross-sectional areas of the respective structural component along a determined or predetermined direction or between two or predetermined ends. In the case that the reference line can run in a curved or at least partially curved manner, the reference direction can generally be understood as a local longitudinal direction. Here, however, the reference direction herein can also be understood as the direction of a straight-line defined reference line, wherein a line is used to determine the straight reference line the position of which relative to the curved line in the sum results in the smallest deviation between these lines or the smallest deviation area. The same applies, if a straight reference line from a curved line is to be derived herein.

In particular, the term “substantially” in relation to a feature or a value is understood herein to mean which the feature contains a deviation of 20% and especially of 10% of the feature or its geometric property or value.

“Orientation” with respect to a surface and in particular surface is understood herein to mean the normal to the respective surface. In the case that the surface in question is not a straight but, for example, a curved surface, the normal to a straight surface of the same size can be used to determine the surface normal, for the orientation of which, relative to the curved surface, in the sum the smallest deviation results.

An “extension” of a surface portion is understood to mean a direction of a planar surface portion which runs along the surface portion which is referred to and comprises such a orientation with respect thereto, in which the sum of the deviation between the two surface portions is minimal. With respect to a length amount of the extent of a surface portion, a length of a fictive surface portion of the same size is understood herein in a direction to be defined which comprises a orientation relative to the referenced surface portion, in which the sum of the deviation between the two surface portions is minimal.

The term “continuous” or “continuously connected”, in particular with respect to a surface or a structural component extending in at least one longitudinal direction, such as a skin, a plate or wall, is understood herein to mean which the surface or structural component extends continuously.

By a “continuous course” of a line or edge or surface is meant that the surface comprises no corner, as seen along a reference direction, over the entire width extending transversely to the reference direction, i.e., comprises a differentiable profile. By a “curved course of a line or edge or surface” is meant that the surface does not comprise a corner, as seen along a reference direction, over the entire width extending transversely to the reference direction, i.e., comprises a differentiable course.

The term “operational area” is understood herein to mean an area of movement of the vehicles or devices described herein when they are moved or moved as intended. The operational area provides, in particular, a surface which provides an operational surface or driving support for the vehicle according to the invention and the at least one tool device used in this context as well as of load units to be moved by these. The operational surface or driving support is a surface which extends, for example, in a planar manner. In this case, the operational surface can comprise a continuous course. Alternatively or additionally, the operational surface can comprise stages, small ramps, thresholds. The operational surface can also be formed from floors of a plurality of halls.

The vehicle according to the invention is provided in particular for carrying out driving movements on an operational surface of an operating region. The operational surface is formed as a contact support for the vehicle. The operational surface may be a continuous surface, or a discontinuous surface, such as a grid, wherein the operational surface forms a surface which extends planar. In this case, the surface may also comprise steps and shapes such as ramps or steps or channels.

The term “position” of a point such as a reference point or a body is understood herein to mean the position of the point, such as the reference point or the body, defined in surface coordinates/spatial coordinates and in particular in the three spatial coordinates. In the case of a position of a body, in particular the position of a center or center point and in particular the center of gravity of the body is understood here.

The vehicle according to the invention is in particular a self-controlling vehicle, i.e., it can perform predetermined tasks without manual control, but rather the driving movements of the vehicle designed for task fulfillment take place automatically, i.e., without manual intervention.

Vehicle state is understood herein to mean a state of the vehicle which is defined by one or more of the following statements: by a position, a speed and an actual orientation of the vehicle, in particular of a longitudinal axis of the vehicle. The vehicle state can be, in particular, a vehicle target state or a vehicle actual state of the vehicle, which is a temporally actual vehicle state.

The combination of a speed and a (travel) direction of a vehicle or of a device and in particular of a tool device can be defined by a speed vector of the vehicle or of the tool device, since this indicates the amount of the speed and the (drivin) direction of the vehicle or of the tool device. Velocity vector is understood herein to mean a combination of data which indicate the speed and the (travel) direction of the vehicle or the tool device. The velocity vector may also correspond to the speed vector state in which the vehicle or a device is not moved, i.e., the magnitude of the speed is equal to zero.

An “orientation” of a vehicle or a tool device is understood to mean a direction of a defined or predetermined longitudinal axis of the vehicle or of the tool device. The longitudinal axis can in particular be a center line or central axis of the vehicle or the tool device. The orientation of the vehicle or the tool device is in particular a direction which can be stored as a reference in the control function. The orientation of a vehicle can in particular coincide with the direction of travel of the vehicle which the vehicle has at one of a neutral position of the running gear or the wheels of the running gear and in particular a neutral position of the running gear or of the wheels of the running gear adjusted by a steering device.

The position and the speed of the vehicle can in particular be related to a predetermined reference point of the vehicle.

The term tool state is understood herein to mean a state of the tool device, which is defined by one or more of the following statements: a position, a speed and an actual orientation of the tool device, in particular a longitudinal axis of the tool device. The tool state can in particular be a tool target state or a tool actual state of the vehicle, which is a temporally actual tool state. The position and speed of the tool device can in particular be related to a predetermined reference point of the tool device. The longitudinal direction is a direction which is stored as a reference in particular in the control function.

The target tool state can be defined, for example, by a state of the tool device relative to a state of a load unit to be received or conveyed by the tool device, wherein these states satisfy one or both of the following conditions:
(b1) the orientation of the tool device and the connection line between a predetermined center or a predetermined center of gravity of the tool device and a predetermined center or center of gravity of the load unit are identical or lie in a predetermined angular range, eg an angular range between 0 degrees and 45 degrees,
(b2) the predetermined center or the center of gravity of the tool device and the predetermined center or the center of gravity of the load unit lie at a predetermined distance or distance range from one another such which a receiving device of the tool device in an activated state moves the load unit onto a receiving component of the vehicle.

The term task fulfillment is understood here to mean that the vehicle in the operational area fulfills mission tasks, which are in particular logistics tasks. A logistics task is the approach of a vehicle, controlled by a control function, to a tool device and the movement or maneuvering of the tool device by the same vehicle, controlled by a control function, into a predetermined adjustment state relative to a load unit to be received by the tool device.

In particular, “self-controlling” is understood herein with reference to a vehicle that the vehicle fulfills a mission task with control commands transmitted to a drive device for controlling the vehicle, which generates a control function of the vehicle itself by means of control commands on the basis of control target data. The fulfillment of a mission task is in particular the following of determined specific trajectories by the control commands or control commands transmitted to a drive device.

### DESCRIPTION OF DRAWINGS

In the following, In the following, embodiments of the invention will be described with reference to the accompanying figures. The description of features or components of embodiments according to the invention is to be understood here as meaning that a particular embodiment according to the invention, if this is not explicitly excluded, can also comprise at least one feature of another embodiment, in each case as an additional feature of this specific embodiment or as an alternative feature which replaces another feature of this particular embodiment. The figures show:

FIG. 1 shows a first operating constellation on an operational surface, the first operating constellation comprising: a first embodiment of a first vehicle according to the invention, an embodiment of a tool device, three load units and a second vehicle in a second embodiment according to the invention; wherein the load units are located between the second vehicle and the arrangement of the tool device and the first vehicle is located at a distance from the tool device,

FIG. 2 shows an operating constellation which is changed with respect to the operating constellation of FIG. 1 and in which the second vehicle approaches a first load unit and has approached the second vehicle of the tool device,

FIG. 3 shows an operating constellation which is modified with respect to the operating constellation of FIG. 2 and in which, with respect to the operating constellation of FIG. 2, the first vehicle has maneuvered the tool device up to the first load unit and to the second vehicle, wherein the tool device has received the first load unit on a conveying device thereof,

FIG. 4 shows an operating constellation which is changed with respect to the operating constellation of FIG. 3, in which, in relation to the operating constellation of FIG. 3, the first load unit has been loaded by the tool device onto a receiving component of the first vehicle by the tool device and the first vehicle has moved away from the tool device again,

FIG. 5 shows a second operating constellation on an operational surface, the second operating constellation comprising: the first embodiment of the vehicle according to the invention, the embodiment of a tool device according to FIGS. 1 to 4, three load units and a boundary wall of the operational surface; wherein the load units are located between the arrangement of the tool device and the vehicle and the first vehicle is located at a distance from the tool device,

FIG. 6 shows an operating constellation modified with respect to the operating constellation of FIG. 5, in which the vehicle approaches the tool device and the vehicle has maneuvered to a first of the three load units,

FIG. 7 shows an operating constellation, which is modified with respect to the operating constellation of FIG. 6 and in which the first vehicle has moved the tool device together with the first load unit toward the boundary wall in relation to the operating constellation of FIG. 6 and the tool device has received the first load unit on a conveying device thereof,

FIG. 8 shows an operating constellation which is changed with respect to the operating constellation of FIG. 7, in which the first load unit, in relation to the operating constellation of FIG. 7, has been loaded by the tool device onto a receiving component of the first vehicle by the tool device and the first vehicle has moved away from the tool device again,

FIG. 9 shows a functional illustration of an embodiment of the vehicle according to the invention and of the method according to the invention,

FIG. 10 shows a perspective illustration of an embodiment of the vehicle according to the invention, wherein the vehicle comprises a running gear with four wheels, of which two first wheels are designed in their combination as differential rotational wheels, and of which two further wheels are each designed as support wheels, and

FIG. 11 shows a perspective illustration of an embodiment of the vehicle according to the invention, wherein the vehicle comprises a running gear with four wheels, which are designed in their combination as omni-directional wheels.

### DETAILED DESCRIPTION

An embodiment of the vehicle 1 according to the invention and of the method and variants thereof according to the invention are described with reference to FIG. 1. For this purpose, further alternative embodiments with features which differ from the features described with reference to FIG. 1 are described with reference to this figure and also by means of further figures. The features by which the further alternative embodiments differ from the variants can also be provided according to the invention on all the embodiments described herein, specifically both as an alternative to functionally identical or functionally similar features and as additional features.

The vehicle 1 according to the invention can by self-controlling, which is to say can be controlled without manual control, and can, in particular perform at least one predefined mission task or fulfill a sequence of mission tasks in a self-controlling manner by means of corresponding functions provided according to the invention. A predetermined mission task involves an approach of the vehicle 1 to a tool device up to docking on the same on the basis of a target docking trajectory and then maneuvering the vehicle 1 on the basis of a vehicle maneuvering trajectory together with the tool device in such a way which the tool device can receive a load unit and in particular can convey it onto the vehicle and in this case specifically to a receiving component of the vehicle. As a result, the load unit is transferred to the vehicle.

FIG. 1 shows, by way of example, a reference system for the vehicle 1, as can also be defined for the functions used according to the invention. FIG. 1 shows, for example, a longitudinal axis A1, a vertical axis A2 and a transverse axis A3 for the vehicle 1. In particular, it can be provided that these axes A1, A2, A3 converge at a point of the vehicle 1 which is defined as the center of the vehicle 1. Another point may also be defined as the center of the vehicle 1. In particular, a center line can be a longitudinal axis A1 of the vehicle 1. For example, these definitions may be defined for the functions used according to the invention. For example, in these functions, data of position or speed or both position and speed of the vehicle 1 are related to such a center of the vehicle 1. These definitions can be performed individually or in any combination for the functions used according to the invention.

As also shown in FIG. 1, the vehicle 1 comprises a running gear 5, which adjusts the direction of the vehicle 1 on an operational surface E, and a vehicle frame 10 fastened thereto. The vehicle frame 10 comprises a receiving component 7 on which at least one load unit L can be placed. The vehicle 1 can interact with a tool device 100 positioned on the operational surface E, in particular when the vehicle 1 is docked on the tool device 100. The vehicle frame 10 can also be formed from a base part 8 and the receiving component 7, wherein the receiving component 7 is fastened to the base part 8 and can be situated above the base part 8 in particular contrary to the direction of gravity. Furthermore, the receiving component 7 can comprise a receiving surface 9 which is oriented contrary to the direction of gravity. Such a receiving surface 9 is provided for placing at least one load unit L.

The vehicle frame 10 comprises an outer surface 10a, which is oriented at least in a section along the planar extent of the operational surface E.

The vehicle 1 comprises at least one vehicle contact surface and can comprise a plurality of vehicle contact surfaces with which the vehicle 1 can be brought into contact with a tool docking device 101. In the embodiment of the vehicle 1 shown in FIG. 1, the vehicle frame 10 comprises four contact surfaces 11, 12, 13, 14. A contact surface of the vehicle frame 10 can be any surface of the vehicle 1 herein, in particular a surface with an orientation which runs along the surface extension of the operational surface E.

The tool docking device 101 provided according to the invention is formed on an outer surface of the tool device 100 oriented along the operational surface E. FIG. 1 shows, by way of example, a longitudinal axis B1, a vertical axis B2 and a transverse axis B3 for the tool device 100. In particular, it can be provided that these axes A1, A2, A3 converge at a point of the tool device 100 which is defined as the center of the vehicle 1. Another point can also be defined as the center of the tool device 100. In particular, a center line can be a longitudinal axis B1 of the tool device 100. For example, these definitions may be defined for the functions used according to the invention. For example, in these functions, data of position or speed or both position and speed of the tool device 100 are related to such a center of the tool device 100. These definitions can be performed individually or in any combination for the functions used according to the invention.

The term “docking” in the first step is generally understood to mean a mechanical connection between the vehicle 1 and the tool device 100, with which the vehicle 1 can maneuver the tool device 100, i.e. to transmit vehicle movements to the tool device 100, so that the movements of the tool device 100 on the operational surface E are caused or guided exclusively or less by the movements of the vehicle 1. In particular, it can be provided that the tool device 100 comprises no drive with which the tool device 100 could move itself on the operational surface E, or which an optionally present drive device is in a drive-free operating state.

The term “docking” can be understood in particular to mean the application of an outer surface of one of the contact surfaces 11, 12, 13, 14 or a predetermined contact surface of the contact surfaces 11, 12, 13, 14 of the vehicle 1 on an outer surface of the tool device 100 and in particular a predetermined tool docking device 101, if this is predetermined.

The vehicle 1 comprises a drive device 30 arranged on the vehicle frame 10 with at least one motor and optionally additionally a braking device. The drive device 30 is coupled to the running gear 5 and drives the running gear to adjust the speed and direction of the vehicle 1. In particular, the running gear 5 comprises a plurality of wheels, each of which is mounted in a wheel suspension of the running gear 5 and on which the vehicle 1 can be moved and positioned on the operational surface E. In this case, the running gear 5 comprises at least two wheels. The drive device drives at least one wheel of these wheels of the running gear 5 and for this purpose is coupled to the respective one of the at least one wheel.

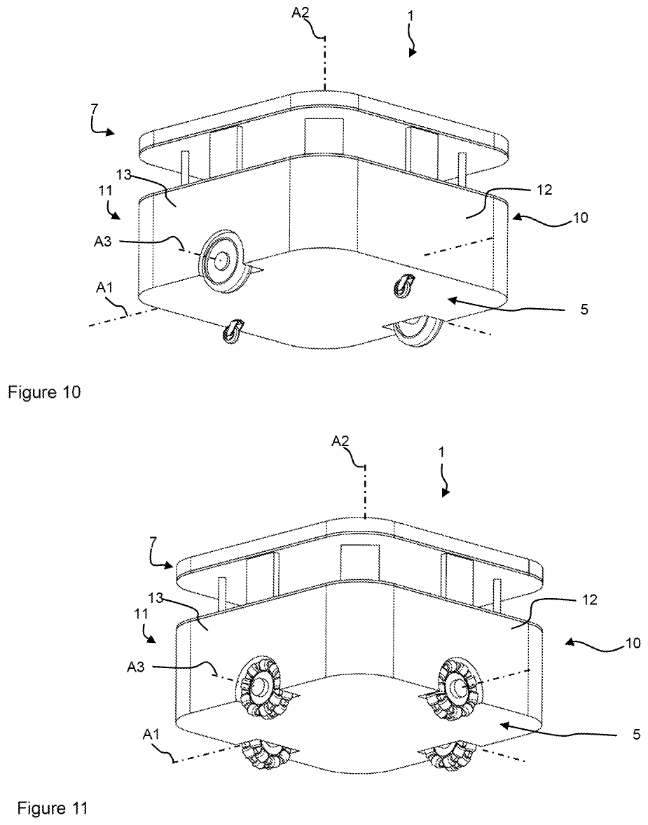

For example, the wheel suspensions of in each case two wheels can be mounted cardanically, so that the respective two wheels can be rotated together in each case about an axis of rotation running transversely to the axes of rotation by in each case a steering device of the running gear 5, which is coupled to the wheel suspensions of the two wheels and is connected to the drive device. A predetermined direction of travel and speed of the vehicle 1 is adjusted on the basis of corresponding control commands which are generated by the drive device and transmitted to the running gear 5 of the vehicle 1. In particular, a predetermined direction of driving of the vehicle 1 can be adjusted on the basis of corresponding control commands which are generated by the drive device and transmitted to the running gear 5. In these embodiments of the vehicle 1, for example, it may be provided that two wheels or two pairs of wheels of a total of four or more than four wheels can perform steering movements. FIG. 10 shows a perspective illustration of an embodiment of the vehicle according to the invention, wherein the vehicle comprises a running gear with four wheels, of which two first wheels, which are each arranged opposite one another with respect to a longitudinal axis of the vehicle, are designed in their combination as differential rotating wheels and of which two further wheels, which are arranged, when viewed in the longitudinal axis, between the two first wheels and opposite one another and in each case, with respect to a transverse axis of the vehicle, and are designed as support wheels, and FIG. 11 shows a perspective illustration of an embodiment of the vehicle according to the invention, wherein the vehicle comprises a running gear with four wheels, which are designed as omni-directional wheels.

Accordingly, the wheel suspensions and wheels of the vehicle 1 can also be designed in such a way that the wheels of the vehicle 1 are realized as omni-directional wheels of the running gear. The vehicle 1 in the embodiment with omni-directional wheels can be moved from an actual position in each direction of driving, provided that there are no obstacles on the contact support in this respect. For this purpose, the running gear 5 of the vehicle 1 can comprise a steering device which is coupled to each of the wheel suspensions of a respective wheel for adjusting the direction of rotation of each wheel and is connected to the drive device. On the basis of corresponding control commands which are generated by the drive device and transmitted to the running gear 5 of the vehicle 1, a predetermined direction of driving and speed of the vehicle 1 is adjusted, wherein the corresponding control commands are transmitted to the steering apparatus in particular for adjusting the direction of the vehicle 1.

Furthermore, the vehicle comprises a control function 50, which is functionally connected to the drive device and determines control commands on the basis of control target data and transmits them to the drive device 30. The drive device 10 generates actuating commands or actuating signals to the running gear on the basis of the control target data in order to drive the wheels of the vehicle 1 and to move the vehicle 1 on the operational surface in a corresponding manner and to adjust a target vehicle state of the vehicle 1 on the operational surface E on the basis of a vehicle actual state of the vehicle 1.

According to the invention, in an initial state, which is shown by way of example in FIG. 1, at least one vehicle 1 is in a first vehicle-actual state at an initial state distance to a tool device 100, which is in a tool actual state. The initial state distance can result in particular from previous movements of the vehicle 1. The initial state distance may be defined, in particular, as the distance between a predefined center of the vehicle 1 and a predefined center or a reference point of the tool device 100. The reference point of the tool device 100 can be any desired location of the tool device 100 or outside the tool device 100, wherein the reference point is therefore located in a fixed manner in a tool device-fixed coordinate system. The reference point of the tool device 100 can in particular be a region such as, for example, a surface region or a point such as, for example, a surface point of the tool device 100. However, the initial state distance may also refer to other points or locations of the vehicle 1 and the tool device 100. For example, the initial state distance can be defined as the distance between the surface center point of a contact surface of the vehicle 1 provided for docking and the surface center point of a contact surface of the docking device 101 of the tool device 100 provided for docking.

In the aforementioned first step, the vehicle 1 moves from the initial state to the vehicle actual state to a first vehicle target state or target docking state in which the vehicle 1 is docked in a predetermined manner on the tool device 100. In a second step, the tool device 100 is maneuvered from its tool actual state into a tool target state on the basis of movements of the vehicle 1, which are effected on the basis of control commands of the control function 50. The movements of the vehicle 1 bring the same in the second step from the first vehicle target state to a second vehicle target state or target recording state, wherein the movements of the vehicle 1 are effected on the basis of control commands which generate the control function 50 of the vehicle system S and which are transmitted by the latter to the vehicle drive device, so that the latter is actuated in a manner that the movements of the vehicle 1 according to the invention are carried out.

To illustrate the first step and the second step mentioned, FIG. 1 shows, for example, a first vehicle 1, a second vehicle 2 and a tool device 100 as well as three load units L1, L2, L3 in each case on an operational surface E. The first vehicle 1 is in a vehicle actual state and is positioned at a distance from the tool device 100 so that the first vehicle 1 has to travel a distance along a target docking trajectory into the target docking state as the mentioned first vehicle target state in which a portion of the outer surface 10a of the vehicle frame 10 is mechanically connected to a predetermined tool contact surface of the docking device 101 of the tool device 100.

The mechanical connection can in particular be a mutual application of an outer side and in particular one of the contact surfaces 11, 12, 13, 14 of the vehicle frame 10 to the tool contact surface or docking device 101. The mechanical connection can also be, in particular, a coupling of the outer side of the vehicle frame 10 to the tool contact surface of the docking device 101, for example by means of a coupling device. The coupling device can be realized magnetically or by a trailer coupling. The first vehicle 1 and the second vehicle 2 can be realized in particular as the same embodiment or as different embodiments of the vehicle according to the invention.

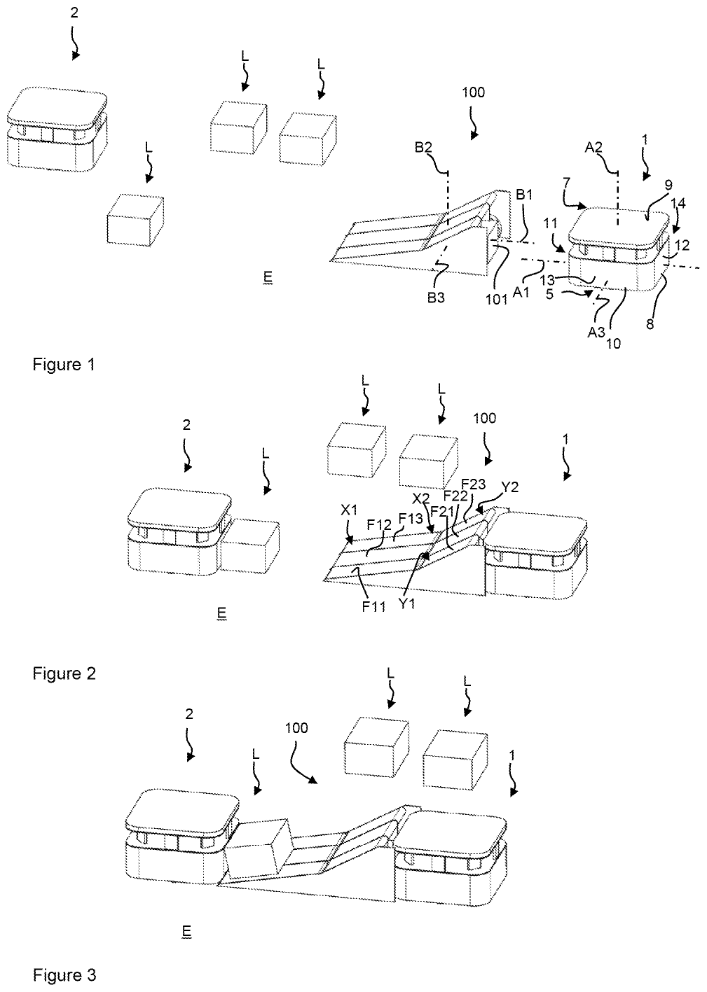

The state of the vehicle 1 and the tool device 100 after the first step, in which the vehicle 1 is in the target docking state at the tool device 100, is shown in FIG. 2. The state of the vehicle 1 and the tool device 100 after the second step, in which the vehicle 1, in a state docked at the tool device 100, has maneuvered the tool device 100 from the mentioned tool actual state into a tool target state is shown in FIG. 3. In this state, the vehicle 1 is in the target docking state and the tool device 100 is in a docked state. In this case, the tool device 100 comprises a position and an orientation on the operational surface E, in which the tool device 100 can receive a load unit L. In particular, it can be provided that the target tool state is defined and predefined in such a way which the reference point position of the reference point of the tool device 100 is situated within a target difference to a load unit position of the load unit L. In addition or as an alternative thereto, it can be defined and specified for the target tool state that the orientation of the tool device 100 is realized in such a way that the load unit position of the load unit L is unambiguously determined and that the load unit L is situated relative to the orientation of the tool device 100 in a target relative region, in particular with respect to a central axis of the tool device 100. In these cases, the target tool state for a respective embodiment of the tool device 100 is defined in such a way which the load unit L can be received by the tool device 100 and can be conveyed by the latter to the vehicle 1.

When the vehicle 1 has moved the tool device 100 into its desired tool state, the vehicle 1 is at the same time in a target receiving state, so that the tool device 100, to which the vehicle 1 is docked, can convey a load unit L to the receiving component 7.

The vehicle 1 or its vehicle system S comprises a docking setting function 60 for defining a target docking trajectory for the vehicle 1 for moving the vehicle 1 from its actual vehicle state into the target docking state at a tool device 100. In the case that the position of the vehicle 1 has a distance which is not equal to zero or a minimum distance from the position of the tool device 100 and the vehicle 1 is to be moved into the first vehicle target state or target docking state, the docking setting function 60 determines a target docking trajectory for moving the vehicle 1 from the actual vehicle actual state to the target docking state of the vehicle 1. The target docking trajectory is determined on the basis of an actual state of the vehicle 1, which is defined at least by an actual position and optionally additionally an actual speed vector, and on the basis of an instantaneous tool actual state of the tool device 100 which is defined by a tool actual position and optionally additionally a tool actual speed vector or optionally additionally a tool actual orientation of the tool device 100. Independently of this, the target docking state of the vehicle 1 can also be predetermined, or predefined or transmitted by an external device, such as in particular a logistics device stationary in the operational area, to the vehicle system S. In this case, the target docking trajectory leads from the vehicle actual state of the vehicle 1 to the target docking state of the vehicle 1.

The target docking state of the vehicle 1 is defined in particular by a target position and optionally additionally a target docking direction, in particular as a component of the target velocity vector of the vehicle 1. In certain embodiments of the vehicle 1, the target docking direction as a determination for the target docking state of the vehicle 1 can be omitted, for example when the vehicle frame 10 is designed in a suitable manner. In particular, for this purpose, the vehicle frame 10 can be designed in such a way that it comprises contact surfaces which are distributed over the outer circumference of the vehicle frame 10 of the vehicle 1. The target docking direction of the vehicle 1 can be provided in such a way which the vehicle 1 has the same orientation as the tool device 100 or has at least an orientation in which the target orientation of the vehicle 1 and the actual orientation of the tool device 100 have an angle with respect to one another between 0 degrees and 60 degrees and in particular 0 degrees and 45 degrees. The actual orientation of the tool device 100 in the target docking state can be provided in particular according to one or more of the following definitions:
(SA1) that the target direction of the vehicle 1 and the actual direction of the tool device 100 coincide;
(SA2) that the target position of the vehicle 1 and the actual position of the tool device 100 differ by the distance between reference points determining the positions of the vehicle 1 and of the tool device 100 in a direction in or along the orientation of the contact surface of docking device 101.

According to the invention, the vehicle 1 or its vehicle system S furthermore comprises a control function 50, which is functionally connected to the docking setting function 60 and determines control target data and transmits them to the drive device in order to adjust the speed vector, which is to say the speed and optionally additionally the orientation of the vehicle 1 located on the operational surface E in such a way that the vehicle 1 moves along the target docking trajectory. In particular in the case of a running gear 5 with omni-directional wheels, it is not necessary for the orientation of the vehicle 1 to be used to determine the target docking trajectory.

In general, the control function 50 can be implemented in such a way that the control target data are generated in the form of control commands to the drive device, at time intervals at a respective point in time at which the vehicle 1 has a respective actual position and optionally a respective orientation or a respective actual speed vector with respect to a point of the respective trajectory assigned to the respective actual position and, for example, of the target docking trajectory generates control target data, wherein by the control target data the vehicle 1 reduces a difference between the respective position and the assigned point of the respective trajectory and, for example, the target docking trajectory, and a difference between the respective orientation or a respective actual velocity vector and the tangent at the associated point of the respective trajectory and, for example, the target docking trajectory. This reduction can take place by means of a control function of the control function 50, which can optionally be functionally connected to the control function, and the control commands for minimizing the distance between the instantaneous actual position of the vehicle 1 and a point of the respective trajectory assigned to this actual position and, for example, the target docking trajectory.

According to one embodiment of the vehicle 1, the vehicle system S of the vehicle 1 comprises a sensor device 40 which determines the actual state of the vehicle 1 and in particular the actual position and optionally the actual orientation or optionally the actual speed vector of the vehicle 1 and transmits the same to the control function 50 and thus provides the same to the latter. The sensor device 40 can also be a functional component of the vehicle system S. For this purpose, the sensor device 40 can comprise a GPS sensor. Alternatively or additionally, the sensor device 40 can comprise a camera or optical sensor which detects markings in the operational area and in particular on the operational surface E and determines from these information the actual position and optionally the actual orientation or optionally the actual speed vector of the vehicle 1.

In order to determine or identify the respective actual position and optionally the respective actual orientation or optionally the actual speed vector of the vehicle 1, in the embodiments of the vehicle 1 or method according to the invention, in combination with otherwise each variants of the vehicle 1 according to the invention described herein, it can be provided that the control function 50 comprises a vehicle communication device 80 which can be brought into radio contact with a logistics device or central control which is stationary in the operational area and receives one or more of the following data:
(d1) data which define an actual position of at least one vehicle 1 according to the invention,
(d2) data which define a target position of at least one vehicle 1 according to the invention,
(d3) data which define an actual orientation of at least one vehicle 1 according to the invention,
(d4) data which define a target orientation of at least one vehicle 1 according to the invention,
(d5) data which define an actual position of at least one tool device 100 provided according to the invention,
(d6) data which define an actual orientation of at least one tool device 100 provided according to the invention,
(d7) data which define a target position of at least one tool device 100 provided according to the invention,
(d8) data which define a target orientation of at least one tool device 100 provided according to the invention,
(d9) data which define an actual position of at least one load unit L provided according to the invention.

The transmission of data by the central control or logistics device to the vehicle communication device 80 can take place in particular at regular time intervals or irregularly, in particular as a function of other processes, or on request by the control function 50 or the vehicle communication device 80. The logistics device is arranged in particular in a region from which the logistics device has radio contact with the at least one vehicle according to the invention, which moves on the operational surface E in particular along a target trajectory.

According to an embodiment of the vehicle 1, the control function 50 is available to the data (d5) and optionally the data (d6), which is to say the actual position and optionally the actual orientation of the tool device 100, in order to determine the target docking trajectory for the vehicle 1. In the embodiments of the vehicle according to the invention, in combination with otherwise any variants of the vehicle described herein, it may be provided which the data (d5) and optionally the data (d6) are determined according to one or more of the following options:
from the logistics device, wherein the latter transmits the data (d5), (d6) to the communication device 80,
from the sensor device 40 of the vehicle 1,
from a sensor device of the tool device 100, wherein the latter transmits the data (d5), (d6) to the communication device 80.

The determination of the target trajectory, i.e., for example, the target docking trajectory or the vehicle maneuvering trajectory, from the actual state of the tool device 100 and the actual state of the vehicle 1 can take place by using and adapting a predefined trajectory. For example, the predefined trajectory can be a straight trajectory which connects the instantaneous actual position of the vehicle 1 and the instantaneous actual position of the tool device 100, in addition to a target rotation of the vehicle 1 in order to transfer the instantaneous actual orientation of the vehicle 1 into the actual orientation of the tool device 100. In this case, the control function 50 can be designed in such a way that the vehicle 1, on the basis of the control commands during driving, takes into account the restrictions of the running gear 5 of the vehicle 1 and, in particular, the steering device, such as the smallest drivable curve radius, the distance between the instantaneous actual position of the vehicle 1 and the target trajectory at any point in time is minimal.

The restrictions of the running gear 5 of the vehicle 1 may in particular depend on the type of running gear 5. For example, these are different in the case of a running gear 5 with omni-directional wheels than in the case of a running gear 5 with gimballed wheels.

Alternatively, it can be provided that the target trajectory comprises a course which already takes into account the restrictions or boundary conditions of the running gear 5 of the vehicle 1 and in particular comprises a curve profile which can be executed by the respective running gear 5 of the vehicle 1. In this case, it can be provided that the trajectory setting function has stored at least one functional type for defining the target trajectory, for example a polynomial function, which is defined by the actual state of the vehicle, target state of the vehicle and a restriction criterion. One or more of the following restrictions can be used as a restriction criterion:
(r1) the mechanical limits of the vehicle steering,
(r2) the weight of the vehicle,
(r3) an energy condition for the movement of the vehicle.

The control target data can additionally also contain speed target data, which is to say a velocity vector. The control setpoint specifications can be determined by the control function 50 in such a way which the time expenditure and energy expenditure for the movement of the vehicle 1 from its instantaneous actual state to the contacting of the contact surface or docking device 101 of the tool device 100 are minimal.

In a further embodiment, the control commands can take into account the movements of other vehicles along the target docking trajectory, in particular with regard to the speed of the vehicle, for example in FIG. 1 the movements of the second vehicle 2.

When the vehicle 1 is docked to the tool device 100, a maneuvering setting function 70 of the vehicle 1 generates a vehicle maneuvering trajectory and a reference point maneuvering trajectory for the tool device 100 to maneuver the tool device 100 from a tool actual state to a tool target state. In this case, the vehicle 1 is moved along the vehicle maneuvering trajectory by means of the control function 50 and a reference point of the tool device 100 is moved along the reference point maneuvering trajectory.

The reference point maneuvering trajectory runs from a respective actual position of the predefined reference point of the tool device 100, in particular at the time of docking of the vehicle 1 to the tool device 100, up to a target distance between the reference point and the position of the load unit L, which is to be moved in each case onto the receiving component 7 of the vehicle 1.

In this case, provision can be made for the vehicle 1 to receive the data (d9), which define an actual position of at least one respectively provided load unit L, from the vehicle 1 via the communication device 80 and to provide the docking setting function 60. In this case, it can be provided that the data (d9) are determined by the logistics device or a sensor device of the tool device 100 and transmitted to or are provided to the maneuvering specification function 70.

The maneuvering setting function 70 comprises a tool movement model which converts data defining a tool state with a tool actual position and a tool actual speed vector of a reference point of the tool device 100 into data which define a vehicle actual position and a vehicle actual speed vector when the vehicle is in a state docked with the tool device 100.

The maneuvering setting function comprises a maneuvering trajectory generation function, which determines, on the basis of a respective tool-actual state, the reference point maneuvering trajectory and, as a function of the latter with the tool movement model, a vehicle maneuvering trajectory into a target receiving state of the vehicle 1, along which the vehicle 1 maneuvers the tool device 100 from a tool actual state to a tool target state, and transmits the vehicle maneuvering trajectory as control target data for moving the vehicle 1 along the same.

With the control function 50, the movement of the vehicle 1 and the tool device 100 on which the vehicle 1 is docked takes place in such a way that the predetermined reference point of the tool device 100 in the tool setpoint state of the tool device 100 lies in the position relative to the position of the load unit L, in which the load unit L is received by the tool device 100 by means of a receiving device of the same and is moved onto the receiving component 7 of the vehicle 1 which is docked to the tool device 100. During the generation of the vehicle maneuvering trajectory, the boundary conditions of the running gear 5 of the vehicle 1 are taken into account, so that the vehicle 1 is able to move technically along the vehicle maneuvering trajectory.

With regard to its friction behavior relative to the operational surface E, the tool device 100 is situated on the operational surface E in such a way which it can move or displace the tool device 100 on the operational surface E by the vehicle 1 when it is docked on the tool device 100 and can thus maneuver into a target tool state. For this purpose, it can be provided that the tool device 100 slides on the operational surface E and in particular is realized without a running gear with wheels. Alternatively, it can be provided that the tool device 100 comprises a running gear with wheels with which the tool device 100 can be moved on the operational surface E. The movement of the tool device 100 which can be realized in each case according to the embodiment of the tool device 100 on the operational surface E by sliding on the operational surface E or by rolling by means of a running gear is taken into account in the tool movement model by corresponding restrictions for the docking state.

The tool device 100 provided according to the invention is realized as a conveying tool which is designed for receiving a load unit L from the operational surface E and for conveying the same to the receiving component 7 of the vehicle 1 and thus for transfer of the load unit L to the receiving component 7 of the vehicle 1. For this purpose, the tool device can comprise a conveyor belt as a conveying device, which can be driven by a drive device of the tool device 100. The conveyor belt is arranged in the tool device 100 in such a way which the same, in a conveying section, extends vertically or obliquely upwards in its longitudinal direction with respect to the direction of gravity so that a load unit L received by the conveying device or charging device can be conveyed to a height above the operational surface E, which exceeds at least the height of the receiving surface 9 of the receiving component 7 of the vehicle 1 in the docked state. The term conveying section is understood herein to mean the section of the conveyor belt which is moved along the conveying direction when the conveyor belt is moved. In particular, the conveying direction can particularly be defined by a conveying section starting point X1, which is situated close above the operational surface E, to a conveying section end point X2, which comprises a greater height than the conveying section starting point X1. Thus, the conveying section can at least partially comprise the height of the receiving surface 9 of the receiving component 7 when the vehicle 1 is in contact with the tool docking device 101. According to one embodiment of the tool device 100, the same comprises a conveyor belt, the conveying section of which extends from the operational surface E to a height which comprises at least the height in which the receiving surface 9 is situated above the operational surface E. The tool device 100 can also comprise a plurality of conveyor belts, which are situated next to one another transversely to the conveying direction, so that the conveying sections of the conveyor belts overall offer a more planar support area for conveying the load units L.

The conveying device can also comprise a plurality of conveyor belts which are situated one behind the other in their conveying direction. These conveyor belts can also have different conveying directions relative to one another. In particular, a conveyor belt located behind a front conveyor belt in the conveying direction can comprise a greater pitch than the respective front conveyor belt.

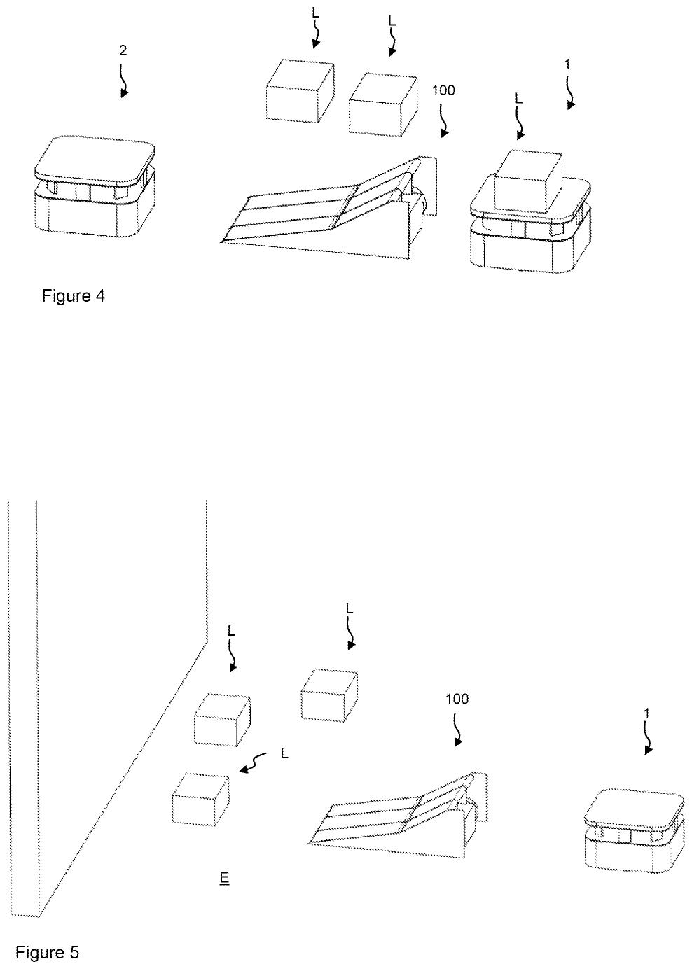

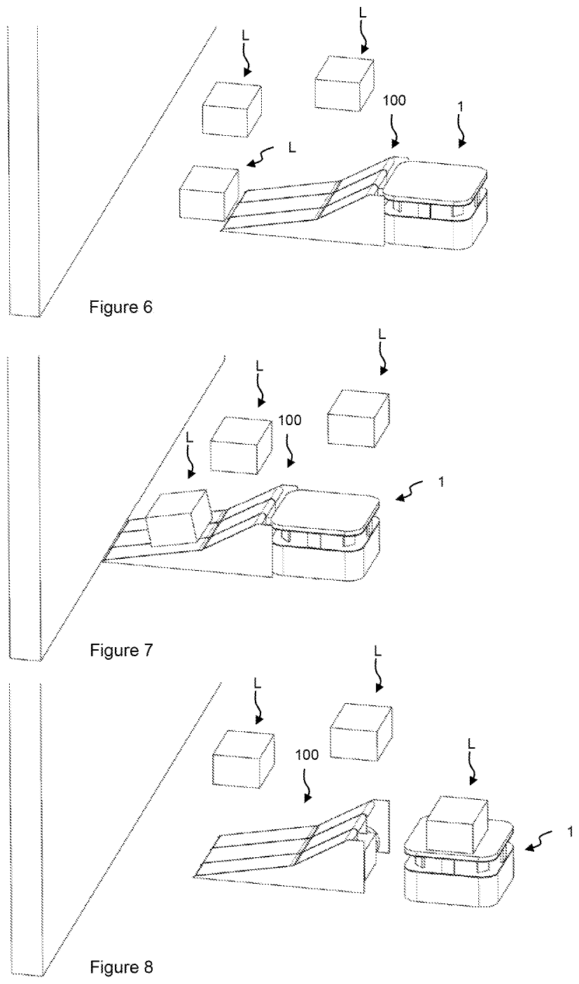

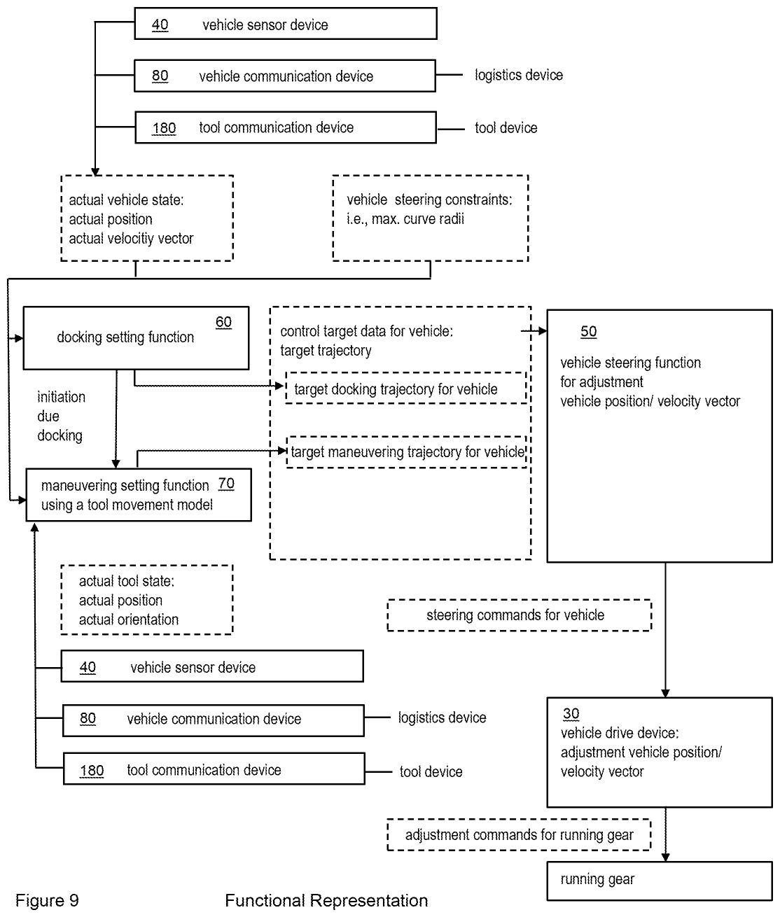

In FIGS. 1 to 8, one embodiment of the tool device 100 is shown, which comprises a first group of three conveyor belts F11, F12, F13 located next to one another transversely to the conveying direction and a second group of three conveyor belts F21, F22, F23 which are situated next to one another transversely to the conveying direction. The conveyor belts of each of the groups have approximately the same conveying direction. Each conveyor belt of the second group is, in each case, situated behind a conveyor belt of the first group, when viewed in the conveying direction, wherein the conveying direction of the conveyor belts of the second group comprises a greater gradient than the conveyor belts of the first group. Each conveyor belt is driven by a drive device of the tool device 100. The conveying directions of the conveyor belts run vertically or obliquely upwards with respect to the direction of gravity, so that a load unit L received by the conveying device or charging device covers a partial path during transport to the receiving component 7 of the vehicle 1.

The conveying device can alternatively also comprise a gripping device with a receiving part which moves in a predetermined manner upon actuation of the gripping device in order to convey a load unit L located on the operational surface E from the operational surface E to the receiving component 7 of the vehicle 1. In the case of the embodiments of the conveying device or charging device, the reference point of the tool device 100 is preferably a point of the tool device 100 which is situated on the conveying device or charging device. In particular, the position of the reference point on the tool device 100 is defined with respect to a predetermined reference point of the tool device 100, wherein the position of the reference point can in particular be defined by a distance from the predetermined reference point of the tool device 100. Optionally, the position of the reference point may additionally or alternatively be defined by a direction to a predetermined central axis of the tool device 100. By defining the position of the reference point, by a tool target state a relative position of the tool device 100 and of the respective load unit L to be conveyed by the latter is defined, in which the load unit L can be picked up and conveyed by the operational surface E.

The conveyor belt can also extend vertically, i.e., the distance between the two deflection sections runs vertically or transversely to the extension of the operational surface E In this case, two conveyor belts can also be provided, which run at a distance and along one another and in particular parallel to one another.

Each conveyor belt can also comprise conveying plates or conveying parts which are brought into contact with the load unit or are moved and which receive the load unit and then raise the same ot the height or a greater height than the height of the receiving surface 9 of the receiving component 7 of the vehicle on the operational surface E. In this case, the reference point can be defined by the position of the conveying plates or conveying parts at their lowermost position during movement of the conveyor belt.

The tool device 100 can comprise a sensor for detecting a load unit identification character or a load unit identification code which is arranged at a location of the charging device in order to detect an identification character or an identification code which is depicted on a load unit L received by the tool device 100 or an identification code contained therein. In this case, it can be provided that a tool communication device of the tool device 100 transmits the identification code or data which are determined from the identification code to the logistics device or to the communication device 80 of the vehicle 1 or both to the logistics device and to the communication device 80.

Alternatively or additionally, the vehicle 1 can comprise a sensor for detecting a load unit identification code or the like, which is arranged at a location of the receiving component 7 in order to detect an identification code or the like, which is depicted on a load unit L received by the receiving component 7. In this case, it can be provided that the sensor provides the identification code or data, which are determined from the identification code, to the communication device 80 of the vehicle 1 and that the same transmits the identification code or the data to the logistics device.

In case that the identification code is detected both by the tool device 100 and by the vehicle 1 and, if appropriate, a recognized identification code or data which was or were determined from the identification code is transmitted to the logistics device, an improved check of the load unit L respectively placed on the receiving component 7 can be carried out by the logistics device.

1-22. (canceled)

23. Vehicle with a running gear, with a drive device which is connected to the running gear and which adjusts a speed vector of the vehicle on an operational surface, and with a vehicle frame which is arranged on the running gear and which comprises a receiving component for placing at least one load unit located on the operational surface, wherein the vehicle comprises a vehicle system with:
a control function which is functionally connected to the drive device and determines control commands based on control target data and transmits them to the drive device to adjust a speed vector of the vehicle,
a docking setting function which generates a target docking trajectory for the vehicle to a target docking state based on data defining a vehicle actual state of the vehicle at least with an actual position, wherein the target docking state is described by data which define at least a target position and wherein, in the target docking state, the vehicle is docked with a contact device of the vehicle frame on a docking device of a tool device, wherein the docking setting function transmits the target docking trajectory to the control function as a control target data for moving the vehicle along the target docking trajectory,
a maneuvering setting function comprising a tool movement model which converts data defining a tool actual state at least with a tool actual position and with a tool actual orientation of a reference point of the tool device into data defining a vehicle actual position and a vehicle actual orientation when the vehicle is in a state docked with the tool device, wherein the maneuvering setting function comprises a maneuvering trajectory generation function which determines, on the basis of a respective tool-actual state, a reference point maneuvering trajectory and which, as a function of the latter, with the tool movement model determines a vehicle maneuvering trajectory into a target receiving state of the vehicle along which the vehicle maneuvers the tool device from the tool actual state to a tool target state in which a reference point position of the reference point is located within a target difference to a load unit position of the load unit, wherein the maneuvering setting function transmits control target data with respect to the vehicle maneuvering trajectory for moving the vehicle along the vehicle maneuvering trajectory to the drive device.

24. The vehicle according to claim 23, wherein the vehicle comprises a reception function which holds the vehicle in this state from the time the vehicle is in the target receiving state relative to the tool target state of the tool device (100) until the tool device has conveyed a load unit to the receiving surface.

25. The vehicle according to claim 23, wherein the vehicle comprises an electrical contacting device formed on a contact surface of the vehicle frame for contacting a docking device of the tool device.

26. The vehicle according to claim 23, wherein the vehicle comprises a vehicle function interface for connection to a tool function interface, wherein the vehicle function interface is formed on a contact surface of the vehicle frame for contacting a contact surface of a docking device of the tool device and wherein the vehicle function interface is provided to transmit an initiation signal for activating a reception function of the tool device for conveying the load unit on the receiving component of the vehicle.

27. The vehicle according to claim 23, wherein the vehicle system comprises a vehicle communication device which can be brought into radio contact with a logistics device which is stationary in the operational area and, upon receipt, transmits data defining a load unit position of at least one load unit to the maneuvering trajectory generation function.

28. The vehicle according to claim 23, wherein the vehicle system comprises a vehicle communication device which can be brought into radio contact with a logistics device stationary in the operational area and, upon receipt of data relating to the tool-actual state of at least one tool device from the logistics device, transmits this data to the maneuvering trajectory generation function.

29. The vehicle according to claim 23, wherein the vehicle system comprises a vehicle communication device, which can be brought into radio contact with a tool communication device of at least one tool device, which transmits data of the tool-actual state of the tool device to the maneuvering trajectory generation function.

30. The vehicle according to claim 23, wherein the vehicle system comprises a vehicle communication device which receives from a tool communication device data related to the tool actual state of the tool device for transmission to the maneuvering trajectory generation function and transmits the data to the maneuvering trajectory generation function based on the receipt.

31. The vehicle according to claim 23, wherein the vehicle system comprises a vehicle communication device which can be brought into radio contact with a tool communication device of at least one tool device or in a line connection with an electrical contacting device which transmits the data related to the tool-actual state of the tool device to the maneuvering trajectory generation function and thereby receives from the tool communication device actual data regarding the load unit position of the load unit at least one load unit located on the operational surface.

32. The vehicle according to claim 23, wherein the vehicle system comprises a prioritization function with which, according to a tool selection criterion at an actual point in time, a tool device is selected as the next tool device from the tool devices located on the operational surface at the actual point in time to be headed for by the vehicle with a target trajectory.

33. The vehicle according to claim 23, wherein the vehicle comprises an identification character sensor which is arranged on the receiving component in order to capture an identification character of a load unit.

34. The vehicle according to claim 33, wherein the identification character sensor is arranged in the direction of gravity below a receiving surface of the receiving component in order to detect an identification character of a load unit.

35. The vehicle according to claim 23, wherein the contact device of the vehicle frame is an outer surface or a coupling device of the vehicle.

36. Method for moving a vehicle on an operational surface and for conveying at least one load unit located on the operational surface onto a receiving component of the vehicle, the method comprising the following steps:
docking the vehicle to a tool device by controlling the vehicle along a target docking trajectory, determined by a docking setting function based on data defining a vehicle actual state of the vehicle with at least one actual position, to a target docking state of the vehicle, wherein the target docking state is described by data which define at least one target position and wherein, in the target docking state, the vehicle contacts a contact device of the vehicle frame of the tool device,
maneuvering the tool device, which is contacted by the vehicle, by controlling the vehicle along a vehicle maneuvering trajectory to a target receiving state of the vehicle as a control target data, wherein the vehicle maneuvering trajectory has been determined based on a reference point maneuvering trajectory and a tool movement model which converts data, which define a tool actual state with a tool actual position and a tool actual orientation of a reference point of the tool device, into data which define a vehicle actual position and a vehicle actual orientation, wherein in the target receiving state of the vehicle the reference point of the tool device is located in a predetermined relative state with respect to the actual position of the load unit.

37. The method according to claim 36, wherein, after reaching the target receiving state of the vehicle, the control function generates control target data with which the vehicle is held in the vehicle receiving state relative to the tool receiving state of the tool device until the tool device has conveyed a load unit onto the receiving component.

38. The method according to one of claim 36,
wherein the tool device determines position data relating to an actual position of the tool device by means of a position sensor device and transmits the data to a tool communication device,
wherein the tool communication device transmits the position data related to an actual position of the tool device via radio contact or via a line connection with an electrical contacting device to a vehicle communication device,
wherein the vehicle communication device transmits the position data related to an actual position of the tool device, after reception of the same, to the maneuvering trajectory generation function.

39. The method according to claim 36,
wherein the tool device determines actual data related to a load unit position of at least one load unit located on the operational surface by means of a load unit sensor and transmits said data via a radio contact or via an electrical line connection with an electrical contacting device to a vehicle communication device,
wherein the vehicle communication device transmits the position data related to a load unit position of the at least one load unit after receiving it to the maneuvering trajectory generation function.

40. The method according to claim 36,
wherein the vehicle system selects, by means of a prioritization function, according to a tool selection criterion, at an actual point in time a tool device as the next tool device from the tool devices located on the operational surface at the actual time to be controlled by the vehicle with a target trajectory,
wherein, on the basis of the selection of the tool device to be headed for next, an initiation of the docking setting function and the determination of the target docking trajectory to the target docking state of the vehicle at the docking device of the selected tool device takes place.

41. The method according to claim 40,
wherein the tool selection criterion performs a comparison of distances between actual positions of the respective tool devices received by the vehicle system and an actual position of a load unit located on the operational surface received by the vehicle system and selects which tool device comprises a smallest distance from the load unit.

42. The method according to claim 40,
wherein the tool selection criterion performs a comparison of distances between actual positions of the respective tool devices received by the vehicle system and the actual position of the vehicle (1) and selects which tool device comprises a smallest distance from the load unit.

43. The method according to claim 36,
wherein after the docking of the vehicle with a contact device of the vehicle frame on the docking device of a tool device and after the maneuvering of the tool device into the tool target state, the tool device conveys the load unit (L) to the receiving component of the vehicle by means of a conveying device,
wherein the conveying device comprises an identification character sensor, past which the load unit is moved during the conveying thereof onto the receiving component and an identification character of a load unit is detected,
wherein the identification character sensor of the tool device is functionally connected to the tool communication device and transmits the identification character to the tool communication device after which the identification character has been captured,
wherein, after receiving the identification character, the tool communication device transmits the same to a logistics device or the vehicle.

44. The method according to claim 36,
wherein, when the load unit is conveyed to the vehicle, an identification character is captured by an identification character sensor of the vehicle,
wherein the identification character sensor of the vehicle is functionally connected to the vehicle communication device and transmits the identification character to the vehicle communication device after which the identification character has been detected,
wherein, after receiving the identification character, the vehicle communication device transmits this to a logistics device.
